(19) United States
(12) Patent Application Publication
(10) Pub. No.: US 2005/0279129 A1
(43) Pub. Date: Dec. 22, 2005

(54) APPARATUS AND METHOD FOR SEPERATING TRITIATED AND HEAVY WATER FROM LIGHT WATER

(76) Inventor: Boris J. Muchnik, Washington, DC (US)

Correspondence Address: GREENBERG & LIEBERMAN, 314 PHILADELPHIA AVE., TAKOMA PARK, MD, 20912, US

(21) Appl. No.: 10/710,071

(22) Filed: Jun. 16, 2004

(51) Int. Cl. C01B 3/00; B01J 8/00; B01D 47/00; C02F 1/22; B01D 9/04; F25J 1/00

(52) U.S. Cl. 62/532; 62/601

(57) ABSTRACT

A process and method to separate heavy water from regular water by lowering the temperature of the mixture to the melting point of the heavy water.

### BACKGROUND OF INVENTION

An apparatus and method for separating tritiated water (HTO) and/or heavy water (D₂O) from light water (H₂O). Water contaminated with tritium is produced as a by-product of nuclear power plants and is a substantial problem due to the detrimental affects of tritiated water on living organisms and the environment. The method of separation prescribed herein is intended to reduce the concentration of tritiated water in a volume of contaminated light water rather than fully separating the tritiated water from the light water.

The method involved is the simplest of methods and relies on the fact that tritiated water freezes at a different temperature than that of light water, i.e. the melting point of the tritiated water is higher than light water by 4.49 degrees Celsius, when frozen is of a different specific density than the light water. Simply put, when a mixture of the tritiated water and the light water is placed at 4.49 degrees Celsius, the tritiated water will fall to the bottom of the mixture and freeze, allowing the light water to be easily drained into a second container.

Nuclear power plants must regularly contend with the disposal and storage of tritiated water. Traditionally the TW is either stored in drums for 10 times its half life (120 years) or it is dispersed into the local streams and environment, hopefully in small enough quantities to create a minimum of havoc on the local ecology, including the humans living in the area. However, it is believed by many that any amount of tritiated water is detrimental to living beings and that it is the primary source of cancer in today's society. Therefore an alternate method of disposal of TW is required.

Many other inventions deal with this subject matter and attempt to solve this problem. However none, before now, have been successful in creating a method that is both effective and economically feasible. For instance: Patent No. 5,954,968 APPARATUS AND METHOD FOR SEPARATING HEAVY ISOTOPES OF HYDROGEN FROM HEAVY WATER issued on 1999-09-21 by Patterson, James A. attempts to separate the HW from the LW by passing the mixture (heavy and light water mixed) through an elongated length of hollow core fiber which is formed of cellulose acetate, thereby attempting to filter out the HW. This method does, to some degree reduce the level of HW in the resulting mixture, but not to a great degree and the hollow fiber is thereafter no longer usable and must be discarded in an equally careful fashion as the original mixture. This of course creates a larger mass of substance which is contaminated with HW and which must be stored or discarded in some fashion.

U.S. Pat. No. 6,190,531 CONCENTRATION AND REMOVAL OF TRITIUM AND/OR DEUTERIUM FROM WATER CONTAMINATED WITH TRITIUM AND/OR DEUTERIUM issued on 2001-02-20 by Meyer, Thomas J.; Narula, Poonam M.; attempts to solve the problem by converting the HTO or HDO into an organic substrate, followed by electrolysis of said subtrate while in the presence of metal oxo complexes thereby oxidizing the protio form of the substrate thereby creating hydrogen gas, and thereby concentrating the heavy isotopes in the water from which it can be subsequently removed. This method is complex, inefficient, expensive, not very effective and rather dangerous. The complexity and expense are of course tied together. It is dangerous because it places a radioactive substance in to a gaseous pressurized form that can accidentally be let out into the atmosphere to the detriment of any body down wind. It is not very effective as it takes a considerable period of time to separate a small amount of the tritium or deuterium when there is a very large quantity that needs to be processed.

U.S. Pat. No. 6,153,092 APPARATUS FOR SEPERATING HEAVY IOSOTOPES OF HYDROGEN FROM WATER issued on 2000-11-28 by Patterson, James A.; Gruber, Martin Josef; Furlong, Louis Edward; is similar to the prior patent except in that the hollow core fibers is filled or packed with small beads that are made up of porous exchange resin. It has all of the same disadvantages of as the prior patent.

U.S. Pat. No. 6,203,483 METHOD FOR SOLVENT EXTRACTION WITH NEAR-EQUAL DENSITY SOLUTIONS issued on 2001-03-20 by Birdwell, Joseph F.; Randolph, John D.; Singh, S. Paul; is a method for the separation of liquids of near equal density using a modified centrifugal contractor with a means for creating a pressure differential between the inside of the rotor and the heavy phase solution outlet. This separation method will not separate heavy and light water, as when they are in the aqueous state their density is exactly the same.

U.S. Pat. No. 5,858,199 APPARATUS AND METHOD FOR ELECTROCORIOLYSIS THE SEPARATION OF IONIC SUBSTANCES FROM LIQUIDS BY ELECTROMIGRATION AND CORIOLIS FORCE issued on 1999-01-12 by Hanak, Joseph J. is a method for separating ionizable compounds out of liquids, such as water, through the use of electromigration (electrolytic or electrostatic increasing the weight of the ionized substances) and thereby separating out said substances through the use of the coriolis effect. This method has many similarities to the current invention in that it takes advantage of a natural process to increase the weight of a substance, which can then be more easily separated from the water. This method is of course ineffective for the separation of heavy water from light water in that the electrolytic and electrostatic affects only the chemical makeup of the mixture and does not affect the nuclear. It therefore is completely ineffective on a mixture of heavy and light water which when in an aqueous state act in the react in the same fashion to electricity.

U.S. Pat. No. 5,451,322 METHOD AND APPARATUS FOR TRITIATED WATER SEPARATION issued on 1995-09-19 by Nelson, David A.; Duncan, James B.; Jensen, George A.; is a membrane method for separating heavy water from light water where the mixture is placed under pressured and forced through a polyphosphazene polymer based membrane. This method has the negative of being very expensive, very complicated (and therefore slow) and because the resulting reaction is exothermic can create a high-pressure system with all of its incumbent hazards.

U.S. Pat. No. 4,411,755 LASER-ASSISTED ISOTOPE SEPARATION OF TRITIUM issued on 1983-10-25 Herman, Irving P., Marling, Jack B. catalytically reacting the heavy light water mixture in an exchange reaction with XYD to produce XYT; irradiating said resulting mixture with a laser thereby dissociating the molecules to x+YT and then chemically separating the YT there from. It is costly, slow, and a high pressure system and as such is dangerous and very complicated requiring expensive equipment.

The subject matter of Tritium Isotope Separation is discussed more fully in Dr. Gheorge Vasaru's book on the subject, which is incorporated herein by reference. The book discusses all of the above methods and is considered to be compendium of all knowledge on the subject to date. It is of course hoped and believed that the subject patent will merit a further chapter in his next update on the subject.

### SUMMARY OF INVENTION

The present invention employs melting points of common water and tritiated water or other types of heavy water. The tritiated water or other types of heavy water is frozen and allowed to sink within the common water mixture. The common water is then removed from the tritiated water or other types of heavy water.

### BRIEF DESCRIPTION OF DRAWINGS

FIG. 1 shows the apparatus employed in the present invention.

### DETAILED DESCRIPTION

Definitions:

Heavy water Where one of the hydrogen atoms in normal water has been replaced by a heavier isotope such as tritium in the case of tritiated water (HTO) or deuterated water (D₂O). It is created in small quantities in nature when cosmic rays interact with nitrogen in the upper atmosphere. These rays interact with nitrogen (¹⁴N) or with deuterium (²H) and form tritium and carbon (¹²C). As these interactions happen in the upper atmosphere the tritium falls to earth in rainfall. It is created in large quantities in nuclear power plants when the inner ring of water being used as a coolant is bombarded with neutrons in a nuclear reactor or an accelerator.

Light Water Normal Water H₂O

Tritium—is a radioactive element. The tritium atom (H) is unstable because it has two extra neutrons in its nucleus. These neutrons give tritium an excess amount of energy. Because of this, the atom will undergo a nuclear transformation or radioactive decay. In this, the atom emits two radiations: a beta particle (β⁻), which is similar to an electron, and an anti-neutrino.

Deuterium—2H is a stable isotope of hydrogen. The nucleus of deuterium (called a deuteron) has one proton and one neutron, whereas a normal hydrogen nucleus just has one proton. Deuterium is also called heavy hydrogen.

Isotope—Isotopes are atoms of a chemical element whose nuclei have the same atomic number, Z, but different atomic weights, A.

The purpose of this invention is to decrease the concentration of tritiated water in the mixture of light and tritiated water and separate one out, as much as possible. In order to do this the mixture must be first filtered using a chemically inert filter and then placed uniformly at 4.49° Celsius. At this temperature tritiated water will turn into a solid state and being heavier than the light water will sink to the bottom of the mixture. The light water can then be easily poured or drained from the container.

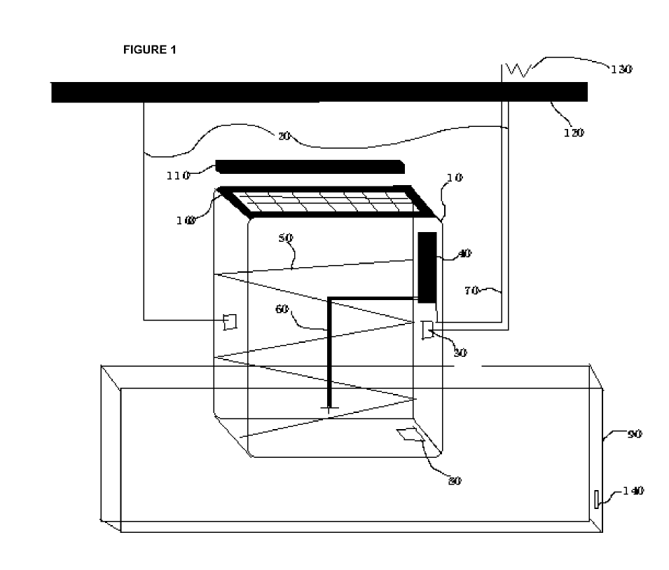

Although numerous methods might be imagined to achieve this result, often the simplest is the best. FIG. 1 shows a see through bucket (10) hanging from ceiling supports (20) which are attached to the bucket (10) via rotating hinges (30) which allow the bucket to be easily moved back and forth or even all the way around, 360°. The mixture (tritiated and light water) is placed in the bucket (10) and a commonly known refrigeration unit (40) is used to lower the temperature to the necessary 4.49° Celsius using standard refrigeration coils (50) placed in and outside of the bucket (10). Also attached to the refrigeration unit (40) is a standard electronic temperature gauge (60), which extends through out the bucket in order to be more precise. The mixture is chilled and stirred in order to increase the uniformity of chilling until the 4.49° Celsius has been maintained for a long enough period of time so that no more solid state phase seems to be forming and dropping to the bottom of the bucket. The user would either open the drain hole (80) in the bottom of the bucket (10) and/or turn the bucket over in order to allow the light water to drain into the pan (90) below. A fine wire mesh or even cheese cloth (100) may be used to help hold the frozen tritiated water in the bucket (10). Further, an insulated lid (110) has been allowed for to make the chilling of the mixture more efficient. This lid (110) is also attached to the bucket (10) via conventional means. Also seen in FIG. 1 is the power cord (70) for the refrigeration unit, a black bar (120) at the top of the figure represents the ceiling, the symbol for electricity (130) and finally the drain hole (140) in the pan.

1. A method of separating tritiated water from light water, comprising:
reducing the temperature of a light and tritiated liquid water mixture to 4.49° Celsius;
allowing the tritiated water to form into the solid state; and
removing the light water from the tritiated water.

2. A method of separating heavy water (D2O) from light water, comprising:
reducing the temperature of a light and heavy water (D2O) liquid mixture to 3.79° Celsius;
allowing the heavy water (D2O) to form into the solid state; and
removing the light water from the heavy water (D2O).
